(19) United States
(12) Patent Application Publication
(10) Pub. No.: US 2017/0171084 A1
(43) Pub. Date: Jun. 15, 2017

(54) VALIANT LOAD BALANCED SEGMENT ROUTING

(71) Applicant: ALCATEL-LUCENT USA, INC., Murray Hill, NJ (US)

(72) Inventors: Fang Hao, Morganville, NJ (US); Murali Kodialam, Marlboro, NJ (US); Tirunellai V. Lakshman, Marlboro, NJ (US)

(73) Assignee: ALCATEL-LUCENT USA, INC.

(21) Appl. No.: 14/963,492

(22) Filed: Dec. 9, 2015

(51) Int. Cl. H04L 12/803

(52) U.S. Cl. CPC H04L 47/125

(57) ABSTRACT

Various exemplary embodiments relate to a routing device used for routing via a valiant load balanced (VLB) intermediate node from a source node i, to a destination node j, the device including a memory, and a processor configured to: for each pair of nodes, (ij), find a cost of using node k≠i as the Shortest Route (SR); for each node i, compute a cost θ(i) of using node k as the VLB intermediate; and compute a node i* that has the minimum θ(i) value.

### TECHNICAL FIELD

Various exemplary embodiments disclosed herein relate generally to computer networking, and more particularly to internet routing.

### BACKGROUND

Traditional routing in Internet Protocol (IP) networks is often along shortest paths using link weight as the metric. It has been observed that under some traffic conditions, shortest path routing may lead to congestion on some links in the network while capacity may be available elsewhere in the network. Segment Routing is a new Internet Engineering Task Force (IETF) protocol to address this problem. The key idea in segment routing is to break up the routing path into segments in order to enable better network utilization. Segment routing may also enable finer control of the routing paths. It may also be used to route traffic through middle boxes connecting the segments.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments are described including a method of routing via an valiant load balanced (VLB) intermediate node from a source node i, to a destination node j, the method including: for each pair of nodes, (ij), finding a cost of using node k≠i as the Shortest Route (SR); for each node i, compute a cost θ(i) of using node k as the VLB intermediate; and compute a node i* that has the minimum θ(i) value.

Various exemplary embodiments are described including A routing device used for routing via a valiant load balanced (VLB) intermediate node from a source node i, to a destination node j, the device including a memory; a processor configured to: for each pair of nodes, (ij), find a cost of using node k≠i as the Shortest Route (SR); for each node i, compute a cost θ(i) of using node k as the VLB intermediate; and compute a node i* that has the minimum θ(i) value.

Various exemplary embodiments are described including a non-transitory computer readable storage device, storing program instructions that when executed cause an executing device to perform a method of routing via an valiant load balanced (VLB) intermediate node from a source node i, to a destination node j, the method including, for each pair of nodes, (ij), finding a cost of using node k≠i as the Shortest Route (SR); for each node i, compute a cost θ(i) of using node k as the VLB intermediate; and compute a node i* that has the minimum θ(i) value.

### BRIEF DESCRIPTION OF THE DRAWINGS

In order to better understand various exemplary embodiments, reference is made to the accompanying drawings, wherein:

FIG. 1 illustrates a network environment;

FIG. 2 illustrates an embodiment of segment routing;

FIG. 3 illustrates an embodiment with exemplary ingress and egress constraints;

FIG. 4 illustrates routing between nodes i and j using VLB;

FIG. 5 illustrates the capacity requirement between nodes i and j;

FIG. 6 illustrates an embodiment of VLS2;

FIG. 7 illustrates an embodiment of VLS4;

FIG. 8 illustrates a VLS4 traffic splitting method;

FIG. 9 illustrates cost structure; and

FIG. 10 illustrates multiple parallel segments between nodes i and k.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although nut explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

With the rapid rise in the number of diverse Internet-based applications, it is to be expected that network traffic patterns will vary widely. Significant traffic fluctuations from what is predicted may require corresponding routing adaptations to avoid congestion. Valiant Load Balancing (VLB), or equivalently two-phase routing, is a scheme that may ensure congestion-free network routing despite incomplete knowledge of the current traffic matrix. By design, VLB uses only aggregate ingress and egress traffic information, or, it only needs the row and column sums of the traffic matrix and not the actual point-to-point traffic. The advent of segment routing may provide a new mechanism for implementing VLB but a straightforward mapping of VLB to segment routed paths may not give good performance. Embodiments include Valiant Load Balanced using 4 Segments or VLS4, which may efficiently implement VLB using segment routing. Embodiments include fast guaranteed approximation algorithms for determining the appropriate segment routing parameters.

Traffic in the Internet may vary rapidly both temporally and spatially due to the increasing number of data intensive applications. The approach of designing networks for expected traffic matrices may lead to performance degradation when traffic does not conform to the expected values. Additionally, making frequent measurement-based changes to the network in real-time to accommodate varying traffic is not desirable. Networks may be over-provisioned to avoid these issues.

Handling traffic uncertainty without resorting to excessive over-provisioning may become a problem. Several schemes for handling this uncertainty have been proposed which pre-configure the network such that a wide variety of traffic patterns may be accommodated without causing network congestion. The only traffic knowledge assumed by these schemes is that the traffic patterns conform to the natural ingress and egress capacities at the edges of the network.

Valiant Load Balancing (VLB) is named after the randomized load balanced work of L. G. Valiant in “A scheme for fast parallel communication,” SIAM Journal on Computing, 11(2), 350-361, 1982, herein incorporated by reference. VLB is discussed to work on structured network topologies. The load balancing based approach may be extended to general topologies as well. The main idea in VLB for general topologies is to route traffic from the source to destination via carefully chosen intermediate nodes called the VLB Intermediates. The VLB intermediates may be chosen to minimize network congestion for any traffic matrix that satisfies the aggregate ingress-egress capacity constraints. VLB may diffuse traffic through the network in order to avoid local bottlenecks. Though simple in principle, implementing VLB may require the use of non-shortest path routing mechanisms such as Multiprotocol Label Switching (MPLS) explicit routing. Additionally, failure recovery mechanisms for the VLB routed explicitly paths may have to be deployed as well. The additional complexity introduced may be a barrier for VLB deployment which offsets the desirable property of being robust to traffic variations. Embodiments include segment routing mechanisms which provide a simpler means for routing traffic through a VLB intermediate.

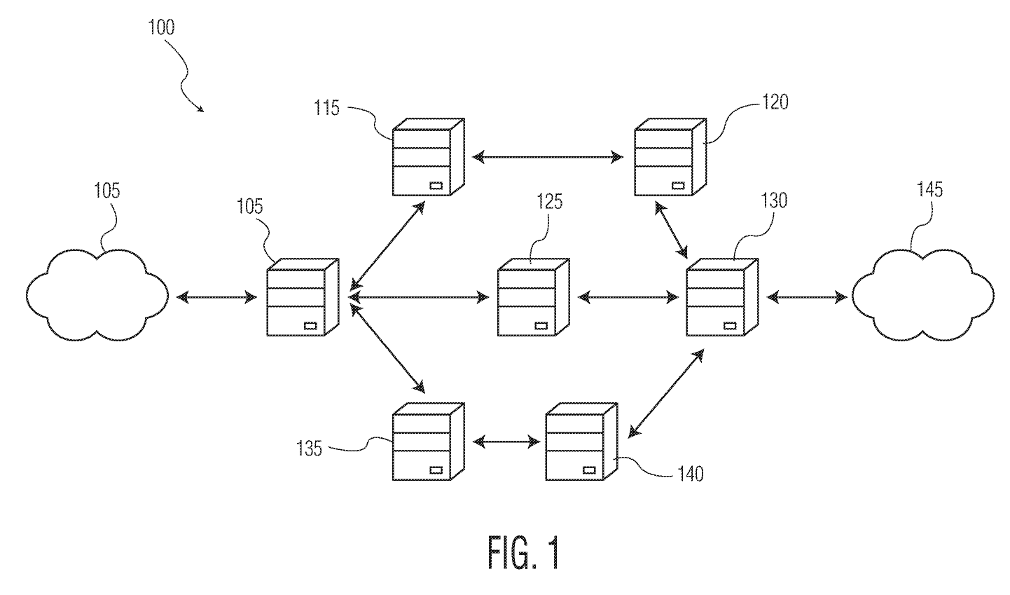

FIG. 1 illustrates an exemplary network environment 100. As shown, the network environment 100 includes networks 105 and 145, connected to network equipment 110, 115, 120, 125, 130, 135, and 140. Network equipment 110, 115, 120, 125, 130, 135, and 140 may be a server, a data center, a blade, a desktop computer, or a node, for example of a data network. Networks 105, and 145 may be any kind of communication networks that are capable of facilitating inter-device communication. In various embodiments, the networks 105 and 145 include an IP/Ethernet network, a telecommunications network such as Public Land Mobile Network (PLMN), or a 3rd Generation Partnership Project protocol, and may include the Internet.

Each of network equipment 105-140 may be connected to an adjacent piece of network equipment 105-140 as pictured. It will be apparent that any configuration of network topology and sequence may be configured including, ring, mesh, star, full connected, bus, tree and line, for example. It will be apparent that fewer or additional pieces of network equipment may exist within exemplary network environment 100. In various exemplary embodiments, network equipment 105-140 may be geographically distributed; for example, network equipment 110, 125, and 130 may be located in Washington, D.C.; Seattle, Wash.; and Tokyo, Japan, respectively. Each piece of network equipment 105-140, may include hardware or software resources for networking including routing capabilities.

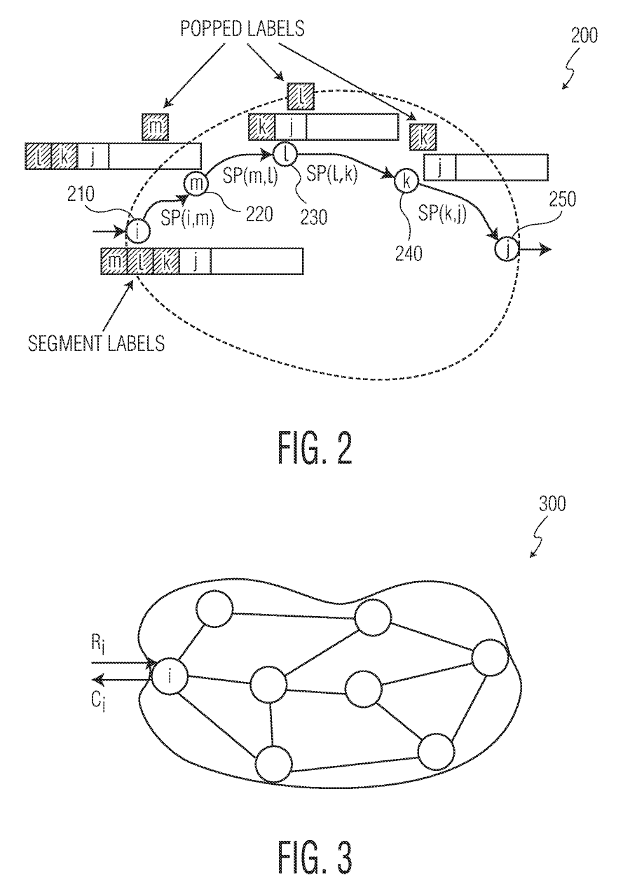

FIG. 2 illustrates an exemplary embodiment of segment routing 200. In an embodiment of segment routing 200 the ingress node, node i 210 may add a set of labels to IP header of the packer with the address of the end point of each segment. Any of nodes: node i 210, node m 220, node t 230, node k 240, and node j 250 may be used. These labels may be used as temporary destination addresses for the segment. The packet may then be routed using the standard shortest path routing algorithm. When the packet reaches the intermediate destination from the ingress, the top level label may be popped by the intermediate destination and now the packet may be routed from the intermediate node to the end point of the next segment again along the shortest path.

Segment routing is a routing mechanism which may enable non-shortest path routing of flows in an Internet Protocol (IP)/MPLS network. Segment routing may break a potential ingress-egress path into a sequence of segments to make possible better path control, than pure shortest path routing and improve overall network utilization. Routing between the end-points of each segment may be along the traditional shortest paths.

The packet may be routed from node i 210 to node j 250 through intermediate nodes m 220, l 230 and k 240. Each of the four pathlets i-m, m-t, t-k, k-j are called segments. The end points of the segments are carried in the packer header and the routing within each segment is along shortest paths computed using conventional Interior Gateway Protocol (IGP) routing protocols. When the packet reaches the intermediate destination, the top level label is popped by the intermediate destination and now the packet is routed from the intermediate node to the end point of the next segment again along the shortest path. Reliance on existing protocols and their enhancements makes segment routing easier to deploy in the network. Segment labels may be globally defined and these labels may be distributed using mostly existing protocols. Segment routing also permits locally defined segment labels. One does not want the number of segments to be too large since this may lead to increased header overhead.

Segment routing may be well-matched for implementing VLB. The source node may add the intermediate node to the packer header and this packet may be routed to the destination via the intermediate node as required by VLB. The drawback of using segment routing is that the shortest path routing in each segment could lead to a under-utilization of network capacity and hence a loss of throughput.

Embodiments include how to implement VLB using segment routing and it is demonstrated that a straightforward implementation of VLB using 2 segment routing (VLS2), may not give good throughput performance. Embodiments include VLS4 which is an efficient way to implement VLB using segment routing. Embodiments include fast guaranteed approximation algorithms to solve for the segment routing parameters for VLS4.

Now is described, an outline of the traffic model and the performance metric that one may optimize when designing VLS4. The traffic model that one may use may commonly be referred to as the hose model.

FIG. 3 illustrates an embodiment with exemplary ingress and egress constraints 300. Traffic in a network may be comprised of internal and external components. External traffic may include the traffic that enters the network at the edge nodes, is routed through the network and egresses typically at some other edge node. Internal traffic may include all the traffic that results in a network when the external traffic is routed across multiple hops in the network. When a traffic matrix is specified, it denotes the external traffic in the network. Let tᵢⱼ denote the (external) traffic between edge nodes i and j in the network. Note that the aggregate amount of external traffic entering or egressing a node is naturally constrained by the capacity of the links that are incident at the nodes that are connected to points outside the network. This hose model may be used in a method for specifying the bandwidth requirements of a Virtual Private Network (VPN).

One may denote the upper bounds on the total amount of traffic entering and leaving the network at node i by Rᵢ and Cᵢ respectively. The point-to-point matrix for the traffic in the network may thus be constrained by these ingress-egress link capacity bounds. Therefore, for any traffic matrix T=[tᵢⱼ], that is admissible must satisfy:

$${\sum }_{j} {t}_{ij} \leq {R}_{i} ∀ i$$

$${\sum }_{j} {t}_{ji} \leq {C}_{i} ∀ i$$

Therefore, given the vectors R and C of the ingress and egress constraints, one may denote the set of admissible traffic matrices:

$$T ( R , C ) = \{ [ {t}_{ij} ] \text{:} {\sum }_{j} {t}_{ij} \leq {R}_{i} ∀ i , {\sum }_{j} {t}_{ji} \leq {C}_{i} ∀ i \} .$$

One may use λT(R, C) to denote the set of all traffic matrices in T(R, C) with their entries multiplied by λ. The row sum for the matrix in λT(R, C) is λR and the column sum is λC. Note that the actual traffic matrix T could be any matrix in T(R, C) and could change over time.

A usual performance metric to evaluate routing algorithms is the maximum link utilization that results from routing a given traffic matrix using the routing algorithm. The lower the maximum link utilization, the better is the algorithm performance. The inverse of the maximum link utilization can be viewed as the throughput of the routing algorithm and one may use throughput to measure algorithm performance. A larger throughput implies better performance. In cases where the traffic matrix T is known, throughput represents the maximum scaling factor λ such that the traffic matrix λT may be routed without violating any link capacities. In the case of traffic-oblivious routing, one may be given the row sum R and the column sum C. One may define the throughput of the algorithm to be the maximum scaling factor λ such that all matrices in λT(R, C) can be routed by the oblivious routing scheme without violating link capacities. Note that the inverse of λ is the maximum link utilization. Maximizing λ is equivalent to minimizing the maximum link utilization. One may compute the maximum λ for all the algorithms and compare the effectiveness of the algorithms by comparing the values of λ.

Valiant Load Balancing—an overview of Valiant Load Balancing in general networks. In VLB, traffic may be routed from source to destination in two phases:
Phase 1: A predetermined fraction αⱼ of the traffic entering the network at any node may be distributed to every node i independent of the final destination of the traffic.
Phase 2: As a result of the routing in Phase 1, each node receives traffic destined for different destinations that it routes to their respective destinations in this phase.

The traffic split ratios in Phase 1 have to satisfy:

$${\sum }_{i = 1}^{n} {α}_{i} = 1.$$

The quantity αᵢ will be referred to as the traffic split ratio corresponding to node i and a set of non-negative traffic split factors summing to one will be referred to as the traffic split vector. FIG. 3 shows routing between nodes i and j using VLB. Traffic may be split according to the split vector, independent of the final destination, and may be routed to the VLB intermediate nodes. The VLB intermediate nodes route traffic to the destination. In practice, traffic may be split based on hashing the packet header so that all packets belonging to a flow may be routed on the same path, thus avoiding packet reordering.

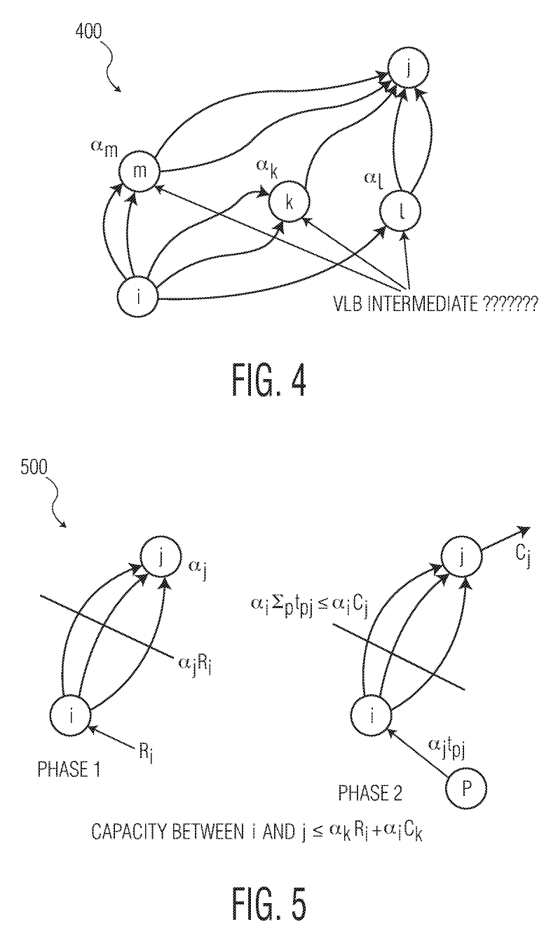

FIG. 4 illustrates routing between nodes i and j using VLB 400. Traffic may be split according to the split ratios αₖ, αᵢ, αₘ. One may derive the bandwidth requirement for the phase 1 and phase 2 paths. Consider a node i with ingress traffic bound of Rᵢ. Node i sends αₖRᵢ amount of this traffic to node k during the first phase for each k. Thus, the traffic demand from node i to node k as a result of phase 1 routing is αₖRᵢ. At the end of phase 1, node i has received αᵢRₚ traffic from any other node p. Out of this, the traffic destined for node k, is αᵢtₚₖ. Since all traffic is initially split without regard to the final destination. The traffic that needs to be routed from node i to node k during Phase 2 is:

$${α}_{i} {\sum }_{p}^{ } {t}_{pj} \leq {α}_{i} {C}_{j} .$$

Thus, the traffic demand from node i to node k as a result of Phase 2 routing is at most αᵢCₖ. Hence, the maximum demand from node i to node k as a result of routing in Phases 1 and 2 is:

αₖRᵢ+αᵢCₖ.

FIG. 5 illustrates the capacity requirement between nodes i and j 500. The capacity computation is illustrated. This quantity may not depend on the matrix TεT(R, C). The VLB scheme may handle variability in traffic matrix TεT(R, C) by effectively routing the fixed matrix D=[dᵢⱼ]=[αⱼRᵢ+αᵢCⱼ] that depends only on aggregate ingress-egress capacities and the traffic split ratios α₁, α₂, . . . , αₙ and not on the specific matrix. This makes the routing scheme oblivious to changes in the traffic distribution. Let Pᵢⱼ represent the set of paths between nodes i and j. Let P represent a generic path. Let x(P) denote the flow sent on path P. The problem of determining the set of α to maximize throughput may be formulated as the following optimization problem:

maxλ

Σ_{PεP}_{ᵢⱼ}x(P)≧αⱼλRᵢ+αᵢλCⱼ∀(ij) (1)

Σ_{P:eεP}x(P)≦c(e)∀e (2)

Σⱼαⱼ=1 (3)

x(P)≧0∀P

αⱼ≧0∀j

The rows and columns may be scaled by λ. Replacing λαᵢ with αᵢ, one can constrain (1) as Σ_{PεP}_{ᵢⱼ}x(P)≧αⱼRᵢ+αᵢCⱼ∀(ij) and constrain (3) as Σⱼαⱼ=λ. The Linear Program (LIP) can now be rewritten as:

$$max {\sum }_{j} {α}_{j}$$

$${\sum }_{P ∈ {P}_{ij}} x ( P ) \geq {α}_{j} {R}_{i} + {α}_{i} {C}_{j} ∀ ( ij )$$

$${\sum }_{P \text{:} e ∈ P} x ( P ) \leq c ( e ) ∀ e$$

$$x ( P ) \geq 0 ∀ P$$

$${α}_{j} \geq 0 ∀ j$$

A combinatorial algorithm has been developed for this problem in “Efficient and Robust Routing of Highly Variable Traffic,” IEEE/ACM Trans. Networking, 17(2), 459-472, 2009, which is incorporated herein in its entirety. One may use λ_{VLB} to denote the throughput of VLB for some given R, C. Therefore VLB may route any traffic matrix whose row and column sums satisfy λ_{VLB}T(R, C). It is shown that VLB performance is almost optimal among the class of algorithms that can make routing decisions dynamically based on the traffic matrix. In spite of the robustness of VLB, it has not been deployed in practice. One may use the throughput of VLB demonstrated, to measure the performance of VLB implementation with segment routing. The objective may be to devise a simple routing mechanism that achieves the same performance as standard VLB.

Since the VLB scheme routes on arbitrary paths in the network the paths should be set up using MPLS explicit path routing. There is overhead in setting up these MPLS tunnels. Moreover, when there are failures in the network, then the tunnels may have to be reconfigured. The complexity of setting up and managing these tunnels may be a barrier to VLB use in practice. In principle, the solution given by the linear program above may be implemented using segment routing by specifying each hop in the routing path as a segment. This approach has a similar drawback as implementing VLB using MPLS explicit paths. VLB may be implemented with less overhead using segment routing. Since segment routing only uses shortest paths, one challenge is to ensure that there is enough capacity to implement VLB.

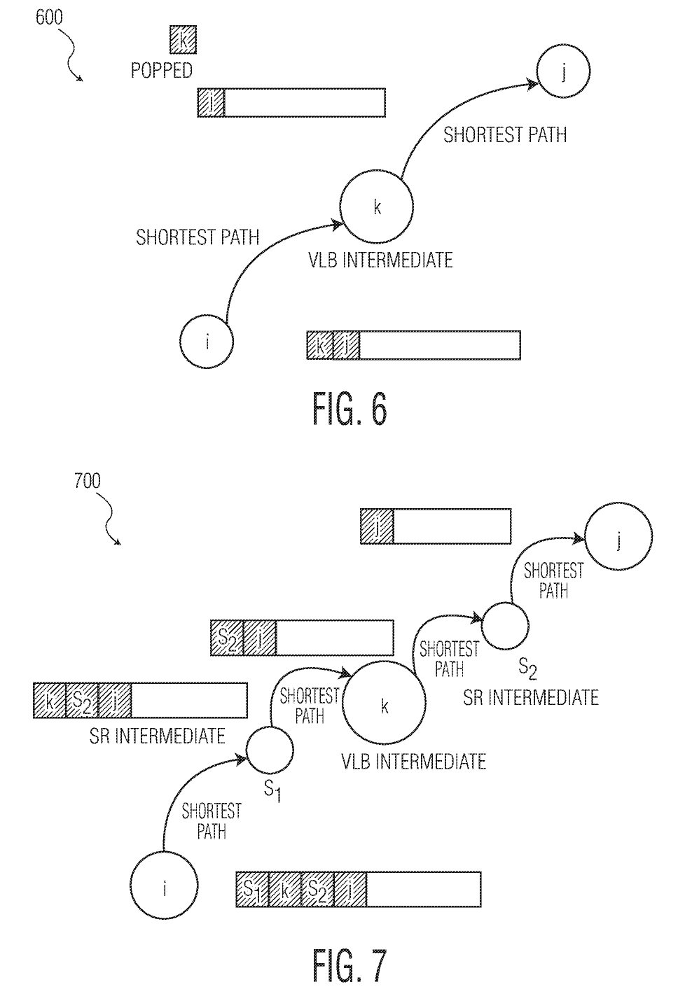

FIG. 6 illustrates an embodiment of VLS2 600. VLS2 is a term being used for VLB using 2-segment segment routing. One method of implementing VLB is to use segment routing for routing traffic through an intermediate node. Segment routing is ideally suited for this purpose. Traffic from node i may be sent through some VLB intermediate node k. Independent of the final destination (for the packet in this Figure it is node j), a fraction αₖ of the packets should be routed through VLB intermediate node k. This may be done by simply pre-pending a segment label k to the packet. Now the packet will be routed from node i to node j through VLB intermediate node k. At node k, the segment label k may be popped and the packer may be routed to destination node j. All routing may be along shortest paths. There is no need to set up any tunnels. Sᵢⱼ is used to denote the shortest path between nodes i and j. One may assume that routing is done along a unique shortest path but the techniques described readily extend to the case where Equal Cost Multi-Path (ECMP) is used to route flows. VLS2 may be straightforward to implement in a segment routed network but also may lose path diversity. One may not be able to exploit the full capacity between any pair of nodes since all routing takes place along shortest paths. The problem of optimally choosing the VLB intermediates and the corresponding traffic split ratios for VLS2 may be formulated as the following LP problem:

$$max {\sum }_{i} {α}_{i} \\ {\sum }_{( ij ) \text{:} e ∈ {S}_{ij}} {α}_{j} {R}_{i} + {α}_{i} {C}_{j} \leq c ( e ) ∀ e \\ {α}_{i} \geq 0 ∀ i \qquad ( 4 )$$

The amount of flow sent between nodes i and j in a VLB scheme is αⱼRᵢ+αᵢCⱼ. This traffic has to pass through every link eεSᵢⱼ. Therefore the left hand side of inequality (4) sums up all the flows on link e and this has to be less than the capacity of link e. This problem can be solved directly using a linear programming solver. However, one may use a simple primal-dual algorithm to solve this problem. This primal-dual algorithm also may provide the template for the more complex primal-dual algorithm for VLS4. One may associate a dual variable of w(e) with the capacity constraint (4) for link e. One may write the dual problem as:

$$min {\sum }_{e} c ( e ) w ( e )$$

$${\sum }_{i \neq k} {R}_{i} {\sum }_{e ∈ {S}_{ik}} w ( e ) + {\sum }_{i \neq k} {C}_{i} {\sum }_{e ∈ {S}_{ki}} w ( e ) \geq 1 ∀ k$$

$$w ( e ) \geq 1 ∀ e$$

The primal-dual algorithm to solve this problem is outlined below in Table 1. The algorithm starts off by initializing w(e) to some computed value δ which is a function of ε and the problem parameters. The algorithm may operate in steps where at each step additional flow is augmented to some VLB intermediate node to and from all nodes in the network. The algorithm is similar to the VLS4 traffic splitting algorithm.

TABLE 1
VLS2 Traffic Splitting:

| αₖ ← 0∀k ε N | |
|---|---|
| w(e) ← δ∀e ε E | |
| flow(e) ← 0∀e ε E | |
| G ← 0 | |
| While | G < 1 do |
| | For all nodes j, Compute |
| | φ(j) = Σ_{i≠j} [RᵢΣ_{eεS}_{ᵢⱼ}w(e) + CᵢΣ_{eεs}_{ⱼᵢ}w(e)] |
| | G ← minⱼφ(j) |
| | if G ≧ 1 break |
| | Let k be the node for which φ(j) is minimum; |
| | $Let α = {min}_{e} \frac{c ( e )}{{Σ}_{i : {S}_{ik} ∋ e} {R}_{i} + {Σ}_{i : {S}_{kl} ∋ e} {C}_{i}}$ |
| | Let Δ(e) = α[ [symbol] Rᵢ + [symbol] Cᵢ] |
| | flow(e) ← flow(e) + Δ(e) for all e |
| | w(e) ← w(e)(1 + εΔ(e)/c(e)) for all e |
| | αₖ ← αₖ + α |

end while
scale(e) ← flow(e)/c(e) for all e ε E
scale_max ← max_{eεE}scale(e)
αₖ ← αₖ/scale_max for all k ε N
Output αₖ as the optimal traffic split vector

One may show that the throughput of VLS2 is significantly lower than VLB mainly due to the fact there is not enough path diversity. One may increase path diversity by segment routing over two hops between the edge nodes and the VLB intermediate node, making it a 4-segment path.

FIG. 7 illustrates an embodiment of VLS4 700. Embodiment 700 includes an efficient segment routed load balanced scheme. While VLS2 may be a straightforward implementation of VLB using segment routing, it may suffer from low throughput since there is not enough path diversity to carry traffic between different node pairs. VLS4 is another embodiment of VLB, using segment routing whose throughput performance matches standard VLB. Unlike VLS2, VLS4 uses a two segment path from the source to the VLB intermediate node and another two segment path from the VLB intermediate node to the destination.

In embodiment 700, consider the traffic from node i to node j. Assume that the traffic is routed through VLB intermediate node k. This may happen to a fraction αₖ of the traffic exiting from node i. Instead of directly routing this traffic to k along the shortest path, the traffic is routed to k via two segments i−s₁ and s₁−k. Similarly, traffic from k to the destination j is routed along two segments k−s₂ and from s₂−j. The segment nodes s₁ and s₂ are picked carefully along with the traffic split factors αₖ in order to maximize the network throughput. N lodes s₁ and s₂, introduced into the routing path to create path diversity for segment routing will be referred to as Segment Routing Intermediate nodes or Shortest Route (SR) intermediates. These SR intermediates are in addition to the VLB intermediates that are introduced for load balancing. Let xᵢⱼ^{k} denote the amount of traffic that is routed from i to j through VLB intermediate node k. The total amount of traffic that has to be routed from i to j may be αⱼRᵢ+αᵢCⱼ. The problem of maximizing the network throughput may be written as the following linear program:

$$\begin{matrix}min {\sum }_{j} {α}_{j} \\ {\sum }_{k} {x}_{ij}^{k} \geq {α}_{j} {R}_{i} + {α}_{i} {C}_{i} ∀ ( ij ) & ( 5 ) \\ {\sum }_{( ijk ) \text{:} e ∈ {S}_{ik} ⋃ {S}_{kj}} {x}_{ij}^{k} \leq c ( e ) ∀ e \\ {x}_{ij}^{k} \geq 0 ∀ ( ijk ) \\ {α}_{j} \geq 0 ∀ j & ( 6 )\end{matrix}$$

One may associate a dual variable w(e) with constraint (6) and θᵢⱼ with constraints (5) to get the following dual problem:

$$min {\sum }_{e} c ( e ) w ( e )$$

$${\sum }_{j \neq p} {R}_{j} [ {\sum }_{e ∈ {S}_{{js}_{1}}} w ( e ) + {\sum }_{e ∈ {S}_{{s}_{2} p}} w ( e ) ] + {\sum }_{j \neq p} {C}_{j} [ {\sum }_{e ∈ {S}_{{ps}_{2}}} w ( e ) + {\sum }_{e ∈ {S}_{s 2} j} w ( e ) ] \geq 1 ∀ {s}_{1} , {s}_{2} , p$$

$$w ( e ) \geq 1 ∀ ; e$$

Embodiment 700 indicates a generic path. Node k represents the VLB intermediate node. Nodes s₁ and s₂ are the segment routing intermediate nodes. Note that s₁ and s₂ can be different for different endpoints i.

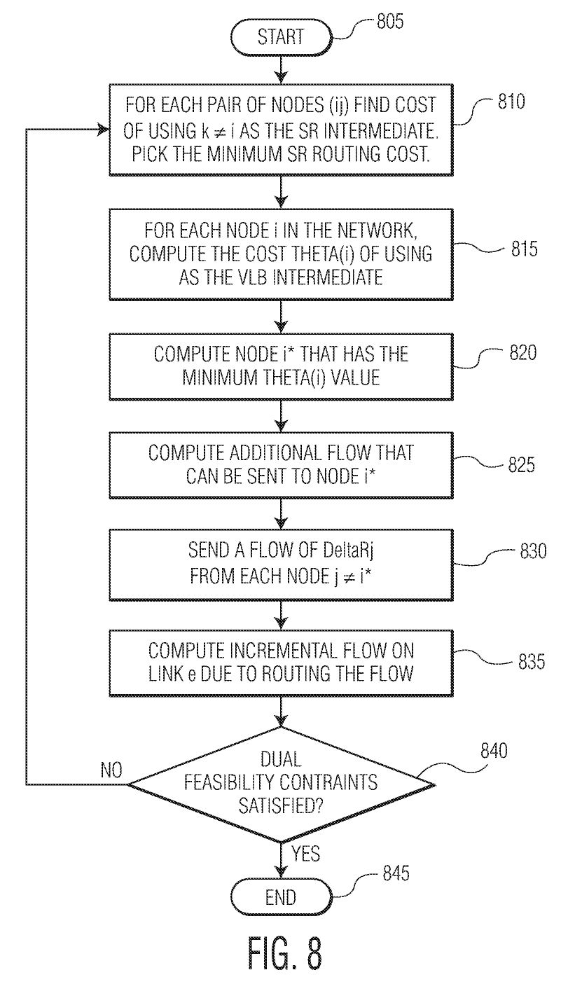

FIG. 8 illustrates a VLS4 traffic splitting method 800. Method 800 may include a primal-dual algorithm for solving the problem. The method may start with equal initial weights w(e)=δ (the quantity δ depends on ε and is derived later). Method 800 may repeat until the dual feasibility constraints are satisfied.

The method 800 may begin in step 805 and proceed to step 810. In step 810 the method may for each pair of nodes (ij) find cost of using k≠i as the SR intermediate as:

$$φ ( i , k , j ) = {\sum }_{e ∈ {S}_{ik}} w ( e ) + {\sum }_{e ∈ {S}_{kj}} w ( e ) .$$

Pick the minimum SR routing cost CSR(i,j) and the corresponding minimum SR intermediate SR(i,j) for each pair of nodes (ij) by computing the node k with the lowest φ(i, k, j).

$$CSR ( i , j ) = {min}_{k \neq i} φ ( i , k , j ) \qquad ( 7 )$$

and the corresponding node that achieves the minimum

$$SR ( i , j ) = Arg {min}_{k \neq i} φ ( i , k , j ) . \qquad ( 8 )$$

Note that the best SR intermediate for (ij) can be node k, in which case traffic is routed from i to j along the shortest path as in VLS2.

The method 800 may proceed to step 815. In step 815, the method may, for each node i in the network, compute the cost θ(i) of using this as the VLB intermediate.

$$φ ( i ) = {\sum }_{j \neq i} {R}_{j} CSR ( j , i ) + {C}_{j} CSR ( i , j ) .$$

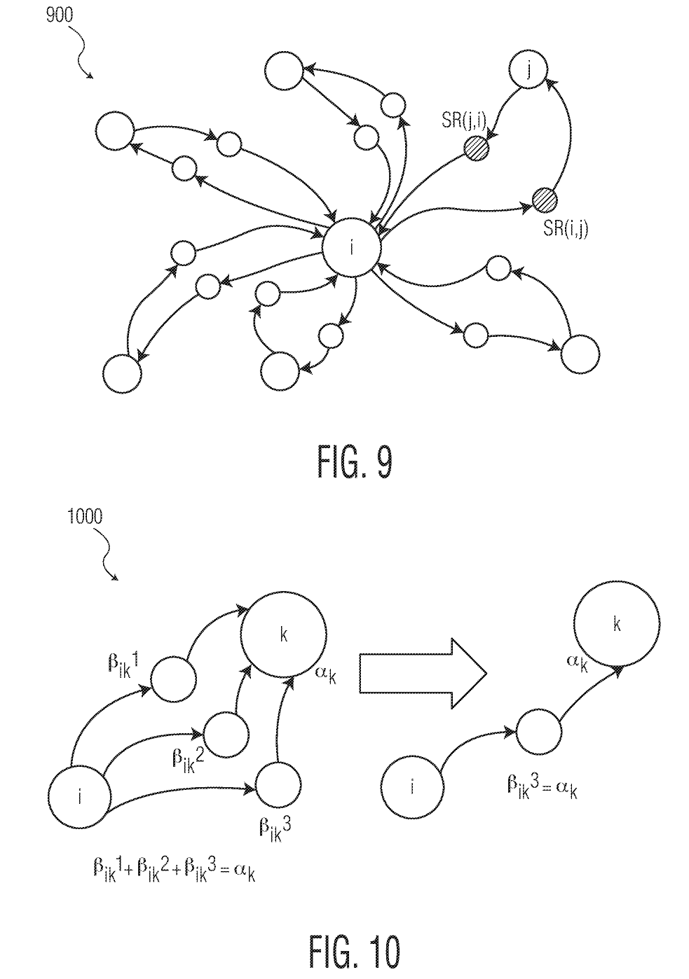

This is the cost of sending flow from each node in the network to VLB intermediate node i via the best SR intermediate. FIG. 9 illustrates cost structure 900 from this step.

The method 800 may proceed to step 820. In step 820, the method may, compute the node i* that has the minimum θ(i) value. An incremental amount of flow may be sent to this node. To keep notation simple one may define u=SR(j,i*) and v=SR(i*, j). Pⱼ=Sⱼᵤ∪Sᵤᵢ* to be the path from j to i* through u and Qⱼ=Sᵢ*ᵥ∪Sᵥⱼ to be the path from i* to j through v.

The method 800 may then proceed to step 825. In step 825, the method may compute the additional flow that can be sent to node i*

$$Δ = {min}_{e} \frac{c ( e )}{{\sum }_{j \neq {i}^{*}} [ {\sum }_{e ∈ {P}_{j}} {R}_{j} + {\sum }_{e ∈ {Q}_{j}} {C}_{j} ]} .$$

The method 800 may proceed to step 830. In step 830, the method may send a flow of ΔRⱼ from each node j≠i*. This flow will be sent along the path j→u→i*. Send a flow of ΔCⱼ to node j from node i* along the path i*→v→j.

The method 800 may proceed to step 835. In step 835, the method may compute the incremental flow δ(e) on link e due to routing this flow. Update the weight of link e:

$$w ( e ) ← w ( e ) ( 1 + ɛ \frac{δ ( e )}{c ( e )} ) .$$

The method 800 may then proceed to step 840. In step 844), the method may determine if the dual feasibility constraints are satisfied. When the constraints are satisfied, the method may proceed to step 845 where it may stop. When the constraints are not satisfied, the method may return to step 810.

The running time for the steps above may be dominated by the computation of φ(i,k,j) for all (i,j) pairs. Computation of φ(i,k,j) is O(n) for each (ikj) combination. Getting CSR(i,j) involves computing O(n) values of φ(i,j,k). There are O(n²) source destination pairs. This gives a overall running time of O(n⁴). Note that the running time in practice is much smaller since the length of the paths as well the number of source-destination pairs does not meet the worst case bounds and this is indeed the case.

When the above procedure terminates, dual feasibility constraints may be satisfied. However, primal capacity constraints on each link will be violated, since we were working with the original (and not residual) link capacities at each stage.

One may scale down the flows and traffic split ratios αᵢ uniformly, so that capacity constraints are obeyed. Note that since the algorithm maintains primal and dual solutions at each step, the optimality gap can be estimated by:

$$O ( \frac{{mn}^{4}}{ɛ} {log}_{1 + ɛ} \frac{L}{{L}^{′}} )$$

where L=(n−1)(Σ_{jεN}Rⱼ) and L′=min_{j:R}_{ⱼ}_{>0}Rⱼ.

Algorithm VLS4 Traffic Splitting computes the maximum throughput within a factor of (1−ε)² of the optimal throughput in time. The algorithm is illustrated in Table 2.

TABLE 2
VLS4 Traffic Splitting:

| $δ = \frac{1 + ɛ}{{L}^{′}} / {[ ( 1 + ɛ ) \frac{L}{{L}^{′}} ]}^{1 / ɛ}$ | |
|---|---|
| αₖ ← 0∀k ε N | |
| w(e) ← δ∀e ε E | |
| flow(e) ← 0∀e ε E | |
| G ← 0 | |
| While | G < 1 do |
| | For each node pair (i, j) compute CSR(i, j) |
| | and SR(i, j) (Equations (7), (8)) |
| | For all nodes i, Compute |
| | φ(i) = Σ_{j≠i}RⱼCSR(j, i) + CⱼCSR(i, j). |
| | G ← minⱼφ(j); |
| | if G ≦ 1 break; |
| | Let i* be the node for which φ(i) is minimum |
| | Let δ(e) = Δ[ [symbol] Rᵢ + [symbol] Cᵢ] |
| | flow(e) ← flow(e) + δ(e) for all e |
| | w(e) ← w(e)(1 + εδ(e)/uₑ) for all e |
| | αₖ ← αₖ + Δ |

end while
scale(e) ← flow(e)/uₑ for all e ε E
scale_max ← max_{eεE}scale(e)
αₖ ← αₖ/scale_max for all k ε N
Output αₖ as the optimal traffic split ratios

FIG. 10 illustrates multiple parallel segments between nodes l and k 1000. Embodiments of the VLS4 algorithm, may only use two-segment paths between any pair of nodes. Consider traffic routed by VLS4 between node i and VLB intermediate k. Let αₖ denote the traffic split factor associated with node k. Traffic can be routed along multiple two-hop segments between nodes i and k. FIG. 1000 illustrates a case where there are three segments between nodes i and k. Let βᵢₖ^{p} denote the fraction of traffic from node i sent to node k along path number p. Note that Σₚβᵢₖ^{p}=αₖ. Therefore, apart from splitting traffic between the VLB intermediates, traffic also has to be split by the source between the different segments between the source and the VLB intermediates. Routing on a single two-segment path between all pairs of nodes will make VLS4 even simpler to implement. The problem of determining the optimal set of a single two-segment path between each pair is an integer programming problem. One may use a randomized rounding scheme to find a single path between each node and the VLB intermediates.

This may be done as follows:
Solve the LP in the last section to determine αₖ and βᵢₖ^{p} for all i, k and for all paths p between i and k.
Set one of the |P| values of βᵢₖ^{p} to one with probability

$$\frac{{β}_{ik}^{p}}{{α}_{k}} .$$

Pᵢₖ denote the path that is picked between nodes i and k.
Compute the link load f(e) as

$$f ( e ) = {\sum }_{( ik ) : e ∈ {P}_{ik}} {α}_{k} {R}_{i} + {\sum }_{( ki ) : e ∈ {P}_{ki}} {α}_{k} {C}_{i} .$$

Compute the maximum link utilization max

$$e \frac{f ( e )}{c ( e )} .$$

Repeat the randomization procedure r times and pick the result that minimizes the maximum link utilization.

This gives a solution where there is precisely one two-segment routed path between each node and the VLB intermediate. One may refer to this routing scheme as RR. This embodiment may be easier to implement than VLS4 since there is no need for a hashing scheme to split traffic between different paths. Traffic may be split between different VLB intermediates using hashing in order to ensure that a flow is not split across multiple intermediates leading to packet reordering.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor may be explicitly shown.

Although the various exemplary embodiments have been described in detail with particular reference to certain exemplary aspects thereof, it should be understood that the invention may be capable of other embodiments and its details are capable of modifications in various obvious respects. As may be readily apparent to those skilled in the art, variations and modifications may be affected while remaining within the spirit and scope of the invention. Accordingly, the foregoing disclosure, description, and figures are for illustrative purposes only and do not in any way limit the invention, which may be defined only by the claims.

What is claimed is:

1. A method of routing via an valiant load balanced (VLB) intermediate node from a source node i, to a destination node j, the method comprising:
for each pair of nodes, (ij), finding a cost of using node k≠i as the Shortest Route (SR);
for each node i, compute a cost θ(i) of using node k as the VLB intermediate; and
compute a node i* that has the minimum θ(i) value.

2. The method of claim 1, further comprising:
finding the SR intermediate according to:
φ(i,k,j)=Σ_{eεS}_{ᵢₖ}w(e)+Σ_{eεS}_{ₖⱼ}w(e); and
picking the minimum SR routing cost, CSR(i,j) and the corresponding minimum SR intermediate SR(i,j) for each pair of nodes (ij) by computing the node k with the lowest φ(i,k,j) using:
$$C S R ( i , j ) = {min}_{k \neq i} φ ( i , k , j ) ;$$
and the corresponding node that achieves the minimum
$$S R ( i , j ) = Arg {min}_{k \neq i} φ ( i , k , j ) .$$

3. The method of claim 2, further comprising:
for each node i in the network, computing the cost θ(i) according to:
$$φ ( i ) = {\sum }_{j \neq i} {R}_{j} C S R ( j , i ) + {C}_{j} C S R ( i , j ) .$$

4. The method of claim 3, further comprising wherein in computing the node i* that has de minimum θ(i) value:
sending an incremental amount of flow to this node, where, u=SR(j,i*) and v=SR(i*,j). Pⱼ=Sⱼᵤ∪Sᵤᵢ* to be the path from j to i* through u and Qⱼ=Sᵢ*ᵥ∪Sᵥⱼ to be the path from i* to j through v.

5. The method of claim 4, further comprising:
computing an additional flow that can be sent to node i* using:
$$Δ = {min}_{e} \frac{c ( e )}{{\sum }_{j \neq {i}^{*}} [ {\sum }_{e ∈ {P}_{j}} {R}_{j} + {\sum }_{e ∈ {Q}_{j}} {C}_{j} ]} .$$

6. The method of claim 5, further comprising:
sending a flow of ΔRⱼ from each node j≠i* along the path j→u→i*; and
sending a flow of ΔCⱼ to node j from node i* along the path i*→v→j.

7. The method of claim 6, further comprising:
computing an incremental flow δ(e) on link e due to routing this flow; and
updating the weight of link e according to:
$$w ( e ) ← w ( e ) ( 1 + ɛ \frac{δ ( e )}{c ( e )} ) .$$

8. A routing device used for routing via a valiant load balanced (VLB) intermediate node from a source node i, to a destination node j, the device comprising:
a memory;
a processor configured to:
for each pair of nodes, (ij), find a cost of using node k≠i as the Shortest Route (SR);
for each node i, compute a cost θ(i) of using node k as the VLB intermediate; and
compute a node i* that has the minimum θ(i) value.

9. The device of claim 8, wherein the processor is con figured to:
find the SR intermediate according to:
φ(i,k,j)=Σ_{eεS}_{ᵢₖ}w(e)+Σ_{eεS}_{ₖⱼ}w(e); and
pick the minimum SR routing cost, CSR(i,j) and the corresponding minimum SR intermediate SR(i,j) for each pair of nodes (ij) by computing the node k with the lowest φ(i,k,j) using:
$$C S R ( i , j ) = {min}_{k \neq i} φ ( i , k , j ) ;$$
and the corresponding node that achieves the minimum
$$S R ( i , j ) = Arg {min}_{k \neq i} φ ( i , k , j ) .$$

10. The device of claim 9, wherein the processor is configured to:
for each node i in the network, compute the cost θ(i) according to:
$$φ ( i ) = {\sum }_{j \neq i} {R}_{j} C S R ( j , i ) + {C}_{j} C S R ( i , j ) .$$

11. The device of claim 10, wherein in computing the node i* that has the minimum θ(i) value, the processor is con figured to:
send an incremental amount of flow to this node, where, u=SR(j,i*) and v=SR(i*,j), Pⱼ=Sⱼᵤ∪Sᵤᵢ* to be the path from j to i* through u and Qⱼ=Sᵢ*ᵥ∪Sᵥⱼ to be the path from i* to j through v.

12. The device of claim 11, wherein the processor is configured to:
compute an additional flow that can be sent to node i* using:
$$Δ = {min}_{e} \frac{c ( e )}{{\sum }_{j \neq {i}^{*}} [ {\sum }_{e ∈ {P}_{j}} {R}_{j} + {\sum }_{e ∈ {Q}_{j}} {C}_{j} ]} .$$

13. The device of claim 12, wherein the processor is configured to:
send a flow of ΔRⱼ from each node j≠i* along the path j→u→i*; and
send a flow of ΔCⱼ to node j from node i* along the path i*→v→j.

14. The device of claim 13, wherein the processor is configured to:
compute an incremental flow δ(e) on link e due to routing this flow; and
update the weight of link e according to:
$$w ( e ) ← w ( e ) ( 1 + ɛ \frac{δ ( e )}{c ( e )} ) .$$

15. A non-transitory computer readable storage device, storing program instructions that when executed cause an executing device to perform a method of routing via an valiant load balanced (VLB) intermediate node from a source node i, to a destination node j, the method comprising:
for each pair of nodes, (ij), finding a cost of using node k≠i as the Shortest Route (SR);
for each node i, compute a cost θ(i) of using node k as the VLB intermediate; and
compute a node i* that has the minimum θ(i) value.

16. The non-transitory computer readable storage device of claim 15, wherein the method further comprises:
finding the SR intermediate according to:
φ(i,k,j)=Σ_{eεS}_{ᵢₖ}w(e)+Σ_{eεS}_{ₖⱼ}w(e); and
picking the minimum SR routing cost, CSR(i,j) and the corresponding minimum SR intermediate SR(i,j) for each pair of nodes (ij) by computing the node k with the lowest φ(i,k,j) using:
$$CSR ( i , j ) = {min}_{k \neq i} φ ( i , k , j ) ;$$
and the corresponding node that achieves the minimum
$$S R ( i , j ) = Arg {min}_{k \neq i} φ ( i , k , j ) .$$

17. The non-transitory computer readable storage device of claim 16, wherein the method further comprises:
for each node i in the network, computing the cost θ(i) according to:
$$φ ( i ) = {\sum }_{j \neq i} {R}_{j} C S R ( j , i ) + {C}_{j} C S R ( i , j ) .$$

18. The non-transitory computer readable storage device of claim 17, wherein the method further comprises:
wherein in computing the node i* that has the minimum θ(i) value:
sending an incremental amount of flow to this node, where, u=SR(j,i*) and v=SR(i*,j). Pⱼ=Sⱼᵤ∪Sᵤᵢ* to be the path from j to i* through u and Qⱼ=Sⱼ*ᵥ∪Sᵥⱼ to be the path from i* to j through v.

19. The non-transitory computer readable storage device of claim 18, wherein the method further comprises:
computing an additional flow that can be sent to node i* using:
$$Δ = {min}_{e} \frac{c ( e )}{{\sum }_{j \neq {i}^{*}} [ {\sum }_{e ∈ {P}_{j}} {R}_{j} + {\sum }_{e ∈ {Q}_{j}} {C}_{j} ]} .$$

20. The non-transitory computer readable storage device of claim 19, wherein the method further comprises:
sending a flow of ΔRⱼ from each node j≠i* along the path j→u→i*; and
sending a flow of ΔCⱼ to node j from node i* along the path i*→v→j.
